(19) United States
(12) Patent Application Publication
(10) Pub. No.: US 2014/0152808 A1
(43) Pub. Date: Jun. 5, 2014

(54) METHOD AND DEVICE FOR THE RELIABLE DETECTION OF MATERIAL DEFECTS IN TRANSPARENT MATERIAL

(71) Applicants: Wolfgang Ullrich, Starnberg (DE); Wolfgang Zorn, Munchen (DE)

(72) Inventors: Wolfgang Ullrich, Starnberg (DE); Wolfgang Zorn, Munchen (DE)

(73) Assignee: Grenzebach Maschinenbau GmbH, Asbach-Bäumenheim (DE)

(21) Appl. No.: 14/234,472

(22) PCT Filed: Jul. 31, 2012
(86) PCT No.: PCT/DE2012/000782

§ 371 Date: Jan. 24, 2014

(30) Foreign Application Priority Data
Aug. 8, 2011 (DE) 10 2011 109 793.0

(51) Int. Cl. G01N 21/88

(52) U.S. Cl. CPC G01N 21/8806
USPC 348/131

(57) ABSTRACT

The invention relates to a method and device for the reliable detection of material defects in a continuously produced band of transparent material by means of examining a strip of a band of this material extending transversely with respect to the conveying direction and observed in transmitted light and reflected light, characterised in that it has the following features: a) uninterrupted illumination of the band of transparent material in transmitted light and reflected light by a linear lamp (6) disposed transversely with respect to the band and having a constant light flux and an adjacent lamp (5) likewise disposed transversely with respect to the strip and having an oscillating light flux, and an additional bright field illumination (8) and an additional dark field illumination (2), wherein the linear lamp (6) has a ruled grating (7) on the surface, b) uninterrupted detection of a detection zone extending over the width of the band of transparent material by means of line scan cameras (9, 1) which are disposed on a fastening portal, c) monitoring the functions of the lamps (5, 6, 2, 8) and the cameras (9, 1), d) an operating program or a learning program for the detection and typing of defects which occur, and a learning program which offers the possibility that points or zones in the transparent material having a certain consistency which are detected as defects are not to be interpreted as inherent defects, but these points or zones are to be classified to a certain extent as insignificant in a learning process.

The invention relates to a device and a method for the checking and detection of transparent or semitransparent objects such as flat glass and/or plastic products with respect to scratches, extraneous inclusions or similar material defects which cause a change of the refractive index in the material.

EP 1 288 651 B1 discloses a device, and a corresponding method, for the determination of optical defects, in particular of the refractive power, in large-area panes of a transparent material such as glass by means of evaluation of the observed image. This device comprises a light source for projecting a defined pattern composed of regular sequences, the sequences comprising at least two different light intensities; furthermore means for arranging the pane to be inspected in the beam path of the projection, and a camera, wherein sequences of the pattern are directed to the pixels of the camera.

With such a device, assumed to be known, the object to be achieved is meant to be to provide a device with which optical defects can be determined in at least one dimension of a pane.

This object is achieved in that the light source is a luminous wall formed as a luminous matrix, which consists of a multiplicity of LEDs which can be driven selectively, preferably in lines and/or in columns.

The sequences must in this case be strictly equidistant and must not have any deviations from their regular structure. Such deviations vitiate the measurement result in this method.

Furthermore, EP 1 477 793 A2 describes a method, and a corresponding device, for the detection of defects in transparent material, in which a defined subvolume of the material is exposed to a first radiation source, and in which light is coupled into the material by a second radiation source in such a way that the light path in the said subvolume extends exclusively inside the material. In this method, a defect in the subvolume is identified by the fact that
a) either light scattered by the defect, or
b) the absorption in the bright field due to the defect and/or
c) the deviation of the light of the first radiation source due to the defect is detected.

The object of the device according to the invention and the corresponding method is to provide a device and a method with which all possible defects which can occur in the transparent material, in particular glass, can be detected and classified reliably. Furthermore, it should be possible for the user at any time to ascertain that the reliability of the operation of the device, or of the method, is ensured.

This object is achieved by a device as claimed in claims 1-3

Claim 1:

A device for the reliable detection of material defects in a continuously produced ribbon of transparent material by testing a strip of a ribbon of this material extending transversely to the feed direction, in transmitted light and direct light, characterized in that it has the following features:

a) a fastening portal (11) in the width of the transparent material to be tested is used as a support of linear cameras (9), the linear cameras (9) covering this width without gaps in respect of their acquisition region and the material ribbon being illuminated in transmission without gaps by means of a linear lighting means (5) with a constant light flux and an adjacent linear lighting means (6) with an oscillating light flux, wherein an additional bright-field illumination (8) illuminates the inspected strip in direct light,

b) the fastening portal (11) is additionally used as a support of further linear cameras (1), the optical axes of which are slightly inclined with respect to the linear cameras (11), the linear cameras (1) also covering said width without gaps in respect of their acquisition region, the linear cameras (1) observing a line grating (7) which lies on the surface of the lighting means (6) and the inspected strip being illuminated in direct light with dark-field illumination (2),

c) a device for monitoring the function of the lighting means (5, 6, 2, 8) and the cameras (9,

Claim 2:

The device as claimed in claim 1,

characterized in that

the line grating (7) covers the surface of the lighting means (6) only on half a side with respect to its longitudinal extent.

Claim 3:

The device as claimed in claim 1 or 2,

characterized in that

a sensor is provided, which records the speed of the ribbon of transparent material and adapts the line frequency of the linear cameras (9, 1) thereto. and respectively by a method as claimed in claims 4-8

Claim 4:

A method for the reliable detection of material defects in a continuously produced ribbon of transparent material by testing a strip of a ribbon of this material extending transversely to the feed direction, in transmitted light and direct light, characterized in that it has the following features:

a) illumination of the ribbon of transparent material without gaps in transmitted light and direct light with a linear lighting means (6) with a constant light flux arranged transversely with respect to the ribbon and an adjacent lighting means (5) with an oscillating light flux, likewise arranged transversely with respect to the ribbon, as well as an additional bright-field illumination (8) and an additional dark-field illumination (2), the linear lighting means (6) having a line grating (7) on the surface,

b) acquisition without gaps of an acquisition region extending over the width of the ribbon of transparent material by means of linear cameras (9, 1) which are arranged on a fastening portal (11),

c) monitoring of the functions of the lighting means (5, 6, 2, 8) and of the cameras (9, 1),

d) an operating program, or a learning program, for detecting and classifying the material defects which occur, as well as a learning program which offers the possibility of evaluating positions or regions detected as defects in the transparent material not as actual errors if they have a certain constancy, but instead so to speak classing these positions or regions as unimportant in a learning process.

Claim 5:

The method as claimed in claim 4,

characterized in that

the learning program contains a function which ensures that definable regions of the ribbon of transparent material can be evaluated in lines according to a particular mode.

Claim 6:

The method as claimed in claim 4 or 5,

characterized in that

the speed of the ribbon of transparent material is detected by means of a sensor and the line frequency of the linear cameras (9, 1) is adapted thereto.

Claim 7:

A computer program having a program code for carrying out the method steps as claimed in one of claims 4 to 6 when the program is run on a computer.

Claim 8:

A machine-readable medium having a program code of a computer program for carrying out the method as claimed in one of claims 4 to 6 when the program is run on a computer.

The device according to the invention will be described in more detail below. Specifically:

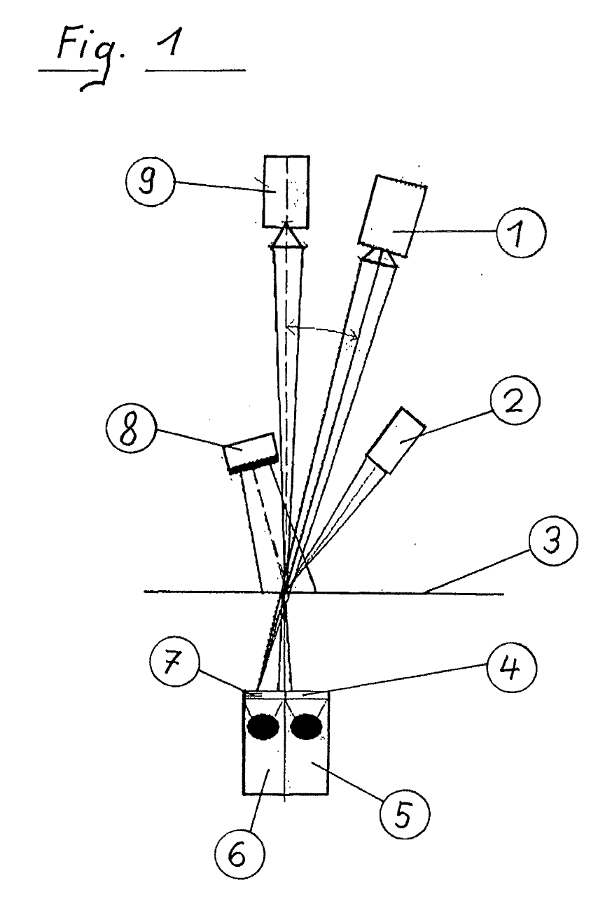

FIG. 1 shows a functional diagram of the device according to the invention,

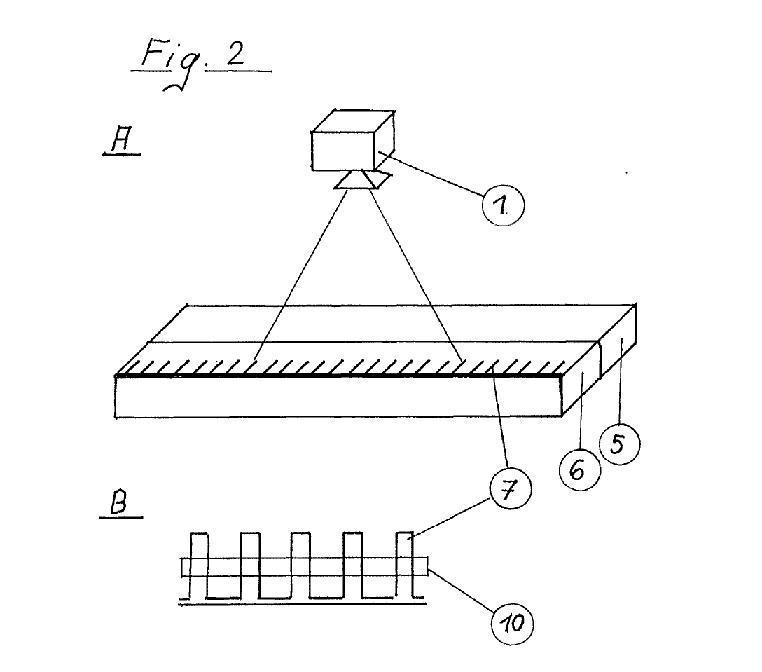

FIG. 2A shows the representation of the illumination via the line grating 7,

FIG. 2B shows an explanation of the illumination via the line grating 7,

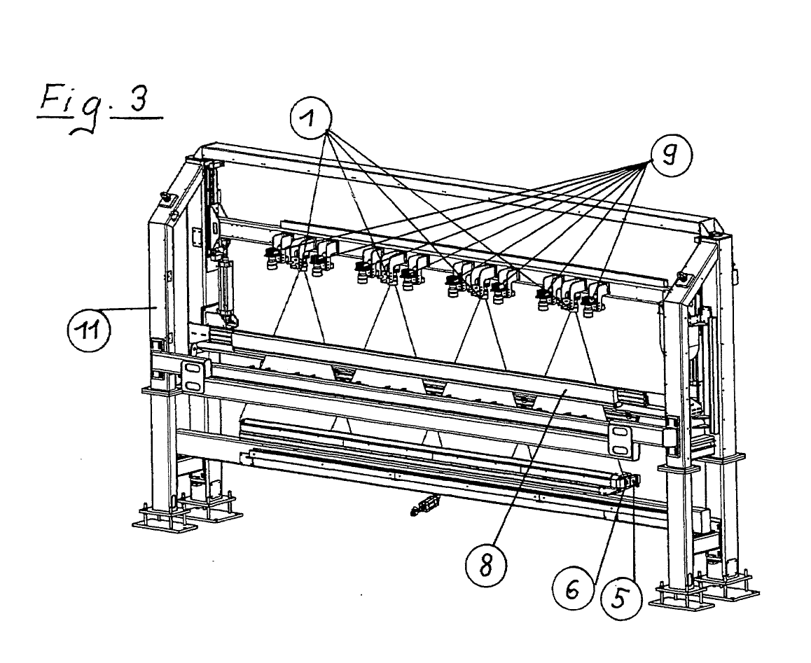

FIG. 3 shows a representation of the spatial arrangement of the device according to the invention,

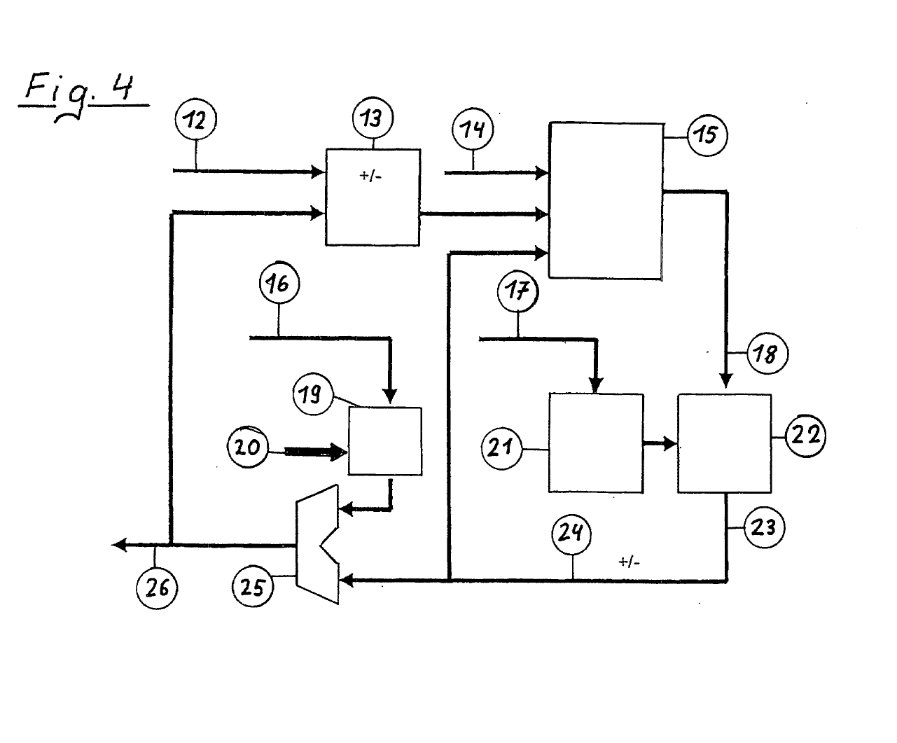

FIG. 4 shows a flowchart of the learning program used.

The device according to the invention makes it possible, on the one hand, to detect and classify all manufacturing defects occurring in a transparent material moving past continuously as a ribbon-like material, for example the constant flow of a float glass ribbon, as well as autonomous constant monitoring of all functional processes. Not only does this provide the user with reliable detection and the possibility of classification, but reliable operation of the device according to the invention is also constantly ensured.

FIG. 1 shows a functional diagram of the device according to the invention. The inspection medium, for example a glass ribbon to be checked, is sketched here as a horizontal line 3. In the middle, one of a plurality of linear cameras 9, which cooperate with the two linear lighting means 5 and 6 represented in section below the horizontal line 3, is shown by way of example as a scan sensor. These lighting means 5, 6 are composed modularly in respect of their length extent, according to the width of the inspection medium to be illuminated, to form an illumination plane 4. Together, they form so to speak two light bands extending parallel, one of which has linearly arranged lighting means 5 oscillating in their light intensity, while the other contains linearly arranged lighting means 6 which are constant in their light intensity. The frequency of the oscillating light intensity is in this case preferably equal to an adjustable line frequency of the linear camera 9, or the frequency of the driving of an alternatively used scan sensor. It is preferred for these frequencies to be in an integer ratio with one another. In the case of a defect-free inspection medium, the observation midpoint of the linear camera 9 lies in the region of the boundary line of the lighting means 5 and 6. When a material defect occurs, this observation midpoint is displaced from this midpoint position owing to light deviation. At the position of the material defect detected, different influences on the output signal of the relevant linear camera 9 therefore take place. From the change in two successive signals of a linear camera 9 and the additional information of the defect position, or the position in the region of the relevant linear camera, a resulting defect signal can be obtained from comparison of the measurement values of two optical channels which are in a relationship with one another, and delivered to a circuit arrangement for defect detection and for further signal processing.

In addition to the linear camera 9 shown, one of a plurality of further linear cameras 1 is represented by way of example in FIG. 1, which is arranged offset at an angle with respect to the linear camera 9, its optical axis extending through the same observation midpoint in the material plane as the linear camera 9, but being directed onto the structure, here by way of example a line grating 7, which lies on half the side (cf. FIG. 2A) of the lighting means 6 with constant light. The bright-field illumination 8 is used, which is represented on the left-hand side of the figure, for illumination of the scene observed by the linear camera 1.

Images which have been formed with dark-field illumination initially appear unusual to the observer. The light is in this case shone in flatly. According to the principle that the angle of incidence is equal to the angle of emergence, all of the light is deviated away from the observer, or the linear camera 1, and the observation field thus remains dark. Topographical defects such as oblique edges, scratches, embossing, depressions and elevations perturb the beam path of the light. At these anomalies, the light is reflected, or usually only scattered, toward the camera. These defects then appear brighter than the background in the camera image. In glass production, these are usually sulfate spots or top tins.

When the line grating 7 is observed by means of a camera 1, any distortion in the transparent material leads to a change in the grating period, which can be detected easily with the aid of the data processing used, which will be described in more detail below (cf. FIG. 4).

With the camera 9, in conjunction with the bright-field illumination 8 represented in the upper left half of the figure, important information can be obtained for the detection of so-called bottom tins (also referred to as tin pickups). Such bottom tins act as a mirror on the lower side of a transparent material, and deliver high-contrast signals in the bright field. By the combination of the two channels—sensor 1 (linear camera) and sensor 9 (linear camera)—defects which are concealed by the structure 7 (line grating) can be identified by the arrangement according to the invention.

In FIG. 2A, the representation of the acquisition of the illumination by means of a linear camera 1 in conjunction with the line grating 7 is represented separately. Here, it can be seen clearly that the line grating 7 occupies only half of the surface region of the lighting means 6, and is arranged next to the lighting means 5. The linear camera 1 is sketched separately over the line grating 7.

FIG. 2B serves to explain the measurement method by means of the line grating 7 on the lighting means 6. Here, the line grating 7 is represented on an enlarged scale with respect to the width of the lines in the sequence of its characteristic line structure. The strip-shaped region 10 sketched transversely to the individual lines of the line grating 7 represents a section of the line grating 7, specially selected for a learning program, which extends in this form in this region over the entire line grating 7.

FIG. 3 shows a representation of the spatial arrangement of the device according to the invention.

The fastening portal 11 can be seen here in a three-dimensional view, the number of linear cameras 9 required for this width, and the corresponding linear cameras 1, being arranged in the upper region. Beside the linear lighting means 5 and the further linear lighting means 6, the bright-field illumination 8 can be seen. The dark-field illumination 2 is concealed in this representation and therefore not representable.

Since the speed of the ribbon of transparent material which passes through in the device according to the invention is important for the operation of the linear cameras, a speed sensor relating to this is provided in the region of the fastening portal 11, the output signal of which is delivered to the control of the system. This sensor is not separately denoted.

Furthermore, the device according to the invention has a further device for monitoring the lighting means (5, 6, 2, 8) and the linear cameras (9, 1), which ensures that no strips of the material ribbon pass unchecked through below the fastening portal 11. The sensors required for this purpose are not separately denoted, and their use is familiar to the person skilled in the art.

FIG. 4 represents a flowchart of the operating program used, or the learning program used therein for carrying out the claimed method steps.

This is essentially a learning program which offers the possibility of evaluating positions or regions detected as defects in the transparent material not as actual errors if they have a certain constancy, but instead so to speak “unlearning” these positions or regions or classing them as unimportant in a learning process.

As an example, in this regard reference is made to the line grating 7, which without the learning program according to the invention would regularly be evaluated as a material defect but, according to the invention, is identified as a constant structure and therefore not detected as a material defect.

For this reason, in the method according to the invention it is not even necessary that the grating structure must have a certain regularity or even equidistance, or that it must be correlated in a particular way with the number of pixels acquired, as is known in methods known from the prior art. This is because the grating structure will anyway be identified as such by program technology however this structure is configured in practice.

Essentially, by means of the learning program according to the invention, a video input signal 16 and a setpoint value 12 are processed in a particular way and a video output signal 26 is obtained therefrom. The video output signal 26 is at the same time delivered to a difference stage 13 where it is either added to the setpoint value or subtracted therefrom, according to the parameter selected.

In the delay stage 19, the video input signal 16 is delivered with a delay by means of an adjustment facility 20 to an adder 25, the other input of which is essentially connected to the output of the stage 15 for offset formation, and added to form a new video output signal. In this case, the delay stage is controlled by the software, corresponding parameters being manually adjustable and the delay algorithm being selectable. The delay stage 19 is controllable since, in the method according to the invention, not every small error should be “unlearnt”; rather, only events which are on the material for a prolonged period of time should be “unlearnt”. In this case, preceding video signals are therefore added and compared with the current video signal. An individual defect is in this case detected, but on the other hand, for example, 100 defects of the same type are not detected. The following maxim governs this: everything which is the same is filtered out, everything which occurs only briefly (1, 2, 3 or 4 scans) is let through and detected in original form, that is to say without a signal change.

The circuit stage 15 is responsible for the offset formation for the next line by means of adjustable attenuation. If, for example, a detected signal has a value of 100 and the corresponding setpoint value should be 50, then, depending on the parameter 14 set, the system may for example jump in steps of 10 or even reach the setpoint value 50 immediately. In this case, how rapidly the system “unlearns” something is therefore decided, while in contrast thereto what is unlearnt is decided in the setting 20. The parameters for the offset adjustment are thus correlated with the learning speed of the system, while the parameters 12 and the adjustment 20 determine what signal is not detected. Since the system according to the invention “unlearns” what is constant, wherever it occurs, tolerances which arise through changes due to development of heat or pressure variations are also compensated for. The system is therefore also generally insensitive to changes during operation and is particularly reliable operationally.

The circuit stage 22 (RAM) and the circuit stage 21 (width counter) with the input 17 (line start) relate to an additional function, the effect of which is that particular regions in a line to be checked on the ribbon of transparent material inspected are treated in a different way than the rest of this line. For example, the edge region of the ribbon inspected, which is not subsequently used, may remain ignored in respect of defects occurring there. The useful region is in such a case defined by the region between “D in” and “D out”.

By means of the optical configuration according to the invention and the operating program, or learning program, according to the invention, the following defect types can be detected and classified.

1) bubbles and inclusions by dark-field illumination and pulsed light 5 and constant light 6,

2) knots (unmelted material particles) by means of the linear camera 1 and the bright-field illumination 8,

3) tin defects (tin pickup, top tin (cold or hot)) by means of the linear camera 9 and pulsed light 5 and constant light 6,

4) sulfate defects

### LIST OF REFERENCES

1 linear camera for the grid reference and dark-field light

2 dark-field illumination

3 glass ribbon (inspection medium)

4 illumination plane

5 lighting means (oscillating light flux)

6 lighting means (constant light flux)

7 line grating

8 bright-field illumination

9 linear camera (optical distortions, pulsed light, bright-field light, dark-field light)

10 section for learning program

11 fastening portal (base frame)

12 parameter, setpoint value

13 difference stage

14 parameter, attenuation

15 offset formation for next line with attenuation

16 video input signal

17 line start

18 D in (line with input attenuation)

19 delay stage

20 adjustment of a delay algorithm

21 width counter

22 RAM (address)

23 D out

24 offset

25 adder

26 video output signal

1. A device for the reliable detection of material defects in a continuously produced ribbon of transparent material by testing a strip of a ribbon of this material extending transversely to the feed direction, in transmitted light and direct light, wherein it has the following features:
a) a fastening portal (11) in the width of the transparent material to be tested is used as a support of linear cameras (9), the linear cameras (9) covering this width without gaps in respect of their acquisition region and the material ribbon being illuminated in transmission without gaps by means of a linear lighting means (5) with a constant light flux and an adjacent linear lighting means (6) with an oscillating light flux, wherein an additional bright-field illumination (8) illuminates the inspected strip in direct light,
b) the fastening portal (11) is additionally used as a support of further linear cameras (1), the optical axes of which are slightly inclined with respect to the linear cameras (11), the linear cameras (1) also covering said width without gaps in respect of their acquisition region, the linear cameras (1) observing a line grating (7) which lies on the surface of the lighting means (6) and the inspected strip being illuminated in direct light with dark-field illumination (2),
c) a device for monitoring the function of the lighting means (5, 6, 2, 8) and the cameras (9, 1).

2. The device as claimed in claim 1, wherein the line grating (7) covers the surface of the lighting means (6) only on half a side with respect to its longitudinal extent.

3. The device as claimed in claim 1 wherein a sensor is provided, which records the speed of the ribbon of transparent material and adapts the line frequency of the linear cameras (9, 1) thereto.

4. A method for the reliable detection of material defects in a continuously produced ribbon of transparent material by testing a strip of a ribbon of this material extending transversely to the feed direction, in transmitted light and direct light, comprising:
a) illuminating of the ribbon of transparent material without gaps in transmitted light and direct light with a linear lighting means (6) with a constant light flux arranged transversely with respect to the ribbon and an adjacent lighting means (5) with an oscillating light flux, likewise arranged transversely with respect to the ribbon, as well as an additional bright-field illumination (8) and an additional dark-field illumination (2), the linear lighting means (6) having a line grating (7) on the surface,
b) acquiring without gaps of an acquisition region extending over the width of the ribbon of transparent material by means of linear cameras (9, 1) which are arranged on a fastening portal (11),
c) monitoring of the functions of the lighting means (5, 6, 2, 8) and of the cameras (9, 1),
d) detecting and classifying the material defects which occur using, an operating program, or a learning program wherein the learning program which offers the possibility of evaluating positions or regions detected as defects in the transparent material not as actual errors if they have a certain constancy, but instead so to speak classing these positions or regions as unimportant in a learning process.

5. The method as claimed in claim 4, wherein the learning program contains a function which ensures that definable regions of the ribbon of transparent material can be evaluated in lines according to a particular mode.

6. The method as claimed in claim 4 wherein the speed of the ribbon of transparent material is detected by means of a sensor and the line frequency of the linear cameras (9, 1) is adapted thereto.

7. A computer program having a program code for carrying out the method steps as claimed in claim 4 when the program is run on a computer.

8. A machine-readable medium having a program code of a computer program for carrying out the method as claimed in claim 4 when the program is run on a computer.
